(19) United States
(12) Patent Application Publication
(10) Pub. No.: US 2021/0102908 A1
(43) Pub. Date: Apr. 8, 2021

(54) X-RAY MEASUREMENT APPARATUS AND SYSTEM

(71) Applicant: Rigaku Corporation, Tokyo (JP)

(72) Inventors: Shota KONNO, Tokyo (JP); Yuji HATAYAMA, Tokyo (JP); Minjung SASAKI, Tokyo (JP)

(73) Assignee: Rigaku Corporation, Tokyo (JP)

(21) Appl. No.: 17/037,384

(22) Filed: Sep. 29, 2020

(30) Foreign Application Priority Data
Oct. 3, 2019 (JP) 2019-183293

(51) Int. Cl. G01N 23/207; G01N 23/20008

(52) U.S. Cl. CPC G01N 23/207; G01N 2223/304; G01N 2223/056; G01N 23/20008

(57) ABSTRACT

There is provided an X-ray measurement apparatus (X-ray diffractometer 2) constituting a measurement system of X-ray analysis from a plurality of components, the X-ray measurement apparatus comprising an apparatus body directly or indirectly attaching each of target components and each of non-target components; each of the target components (selection slit 41) to be attached, the type of the attached target component being recognized by the apparatus body, and each of the non-target components to be attached, the type of the attached non-target component not being recognized by the apparatus body a measurement category; and an indicator (indicator 41a for the selection slit) that indicates whether attachment of each of the target components is appropriate for a measurement category.

### TECHNICAL FIELD

The present invention relates to an X-ray measurement apparatus whose attachment component can be customized, and to provide a system provided with the same.

### RELATED ART

There are X-ray measurement apparatuses each of whose attachment component can be customized. Examples of replaceable components include a slit, a monochromator, a filter, and so forth. Conventionally known is an X-ray measurement apparatus that recognizes a type of each of these components with an electrical signal from a label attached to a component, or from the component itself; and determines whether it is appropriate to be associated with a measurement method to indicate a component to be replaced on a control unit (Refer to Patent Document 1).

Further, also known is an X-ray measurement apparatus where a type of component is specified by taking image of a replaceable component and a label with a camera (Refer to Patent Document 2). Further, also known is an X-ray measurement apparatus provided concurrently with a wavelength dispersive X-ray spectrometer and an energy dispersive X-ray spectrometer, by which an analysis mode or the like is transmitted to an operator with an indication lamp (Refer to Patent Document 3). There is also an X-ray measurement apparatus that determines whether attachment of the component is appropriate for the measurement method, and guides a replacement instruction of an inappropriate component with sound or voice when not being appropriate.

### PATENT DOCUMENT

[Patent Document 1] Japanese Unexamined Patent Application Publication No. 2008-057989

[Patent Document 2] Japanese Unexamined Patent Application Publication No. 2014-077714

[Patent Document 3] Japanese Unexamined Patent Application Publication No. 2010-107334

However, even though the component to be replaced is indicated on indication means by a method of indicating a component to be replaced on the above-described control unit, it is shown by an abstract figure, and thus a position of the component to be replaced is unclear. Accordingly, it takes time to actually find an appropriate replacement place where the component is to be replaced, after an operator turns his/her eyes away from the figure. Further, when positions of an X-ray measurement apparatus and a control unit (display) are away from each other, it becomes necessary to be alternately confirmed by moving a body. Further, in a guiding method with sound or voice, an instruction is hard to be heard under a noisy environment, and thus the load caused by moving to and fro between the control unit and the apparatus cannot necessarily be reduced.

### SUMMARY OF THE INVENTION

The present invention has been made in view of such situations, and it is aimed to provide an X-ray measurement apparatus capable of recognizing whether a component to be replaced or a replaced component is appropriate only from visual information at a working site, without any confirmation by shifting eyes or moving a body, and to provide a system thereof.

(1) In order to achieve the above-described object, it is a feature that the X-ray measurement apparatus according to the present invention is an X-ray measurement apparatus constituting a measurement system of X-ray analysis from a plurality of components, the X-ray measurement apparatus comprising an apparatus body directly or indirectly attaching each of target components and each of non-target components; each of the target components to be attached, the type of the attached target component being recognized by the apparatus body, and each of the non-target components to be attached, the type of the attached non-target component not being recognized by the apparatus body; and an indicator that indicates whether attachment of each of the target components is appropriate for a measurement category.

In this manner, when an operator needs to replace each of the target components therewith for the replacement of the measurement category, whether each of target components to be replaced or each of replaced target components is appropriate is able to be recognized only from visual information at a working site, without any confirmation by shifting eyes or moving a body. Further, information can be easily recognized even when it is not appropriate to be guided by sound or voice.

(2) Further, it is a feature that the X-ray measurement apparatus according to the present invention is the apparatus, wherein the indicator indicates whether attachment of a base component is appropriate on the apparatus body, the base component being one of the target components directly attached to the apparatus body. In this manner, information is accessible even at the working site via indicating to a position where whether attachment of the base component is appropriate is easy to be found.

(3) Further, it is a feature that the X-ray measurement apparatus according to the present invention is the apparatus, wherein the indicator indicates whether the attachment of the base component is appropriate on a connector for electrical connection. In this manner, an operator can confirm whether ach of components to be replaced or each of replaced components is appropriate at a position that is easy to be viewed during an operation, when replacing a base component therewith.

(4) Further, it is a feature that the X-ray measurement apparatus according to the present invention is the apparatus, wherein the indicator indicates whether attachment of a functional component is appropriate on the functional component or an attachment object to which the functional component is attached, the functional component being one of the target components attached to a base component that is directly attached to the apparatus body. In this manner, information is accessible even at the working site via indicating to a position where whether the attachment of the functional component is appropriate is easy to be found.

(5) Further, it is a feature that the X-ray measurement apparatus according to the present invention is the apparatus, wherein the indicator indicates whether the attachment is appropriate near a position of connecting the attachment object to the functional component and in front of a working position of an operator. In this manner, an operator can confirm whether a component to be replaced or a replaced component is appropriate at a position that is easy to be viewed during an operation, when replacing a component therewith.

(6) Further, it is a feature that the X-ray measurement apparatus according to the present invention is the apparatus, wherein the indicator is a lamp. In this manner, installation of the indicator becomes easy.

(7) Further, it is a feature that the X-ray measurement apparatus according to the present invention is the apparatus, wherein the indicator is a light irradiator. In this manner, whether the attachment is appropriate can be indicated without changing a configuration of an apparatus body and components to be replaced.

(8) Further, it is a feature that the X-ray measurement apparatus according to the present invention is the apparatus, wherein the apparatus body allows to indicate whether the attachment of each of the target components is appropriate, after an arm constituting the apparatus body moves into a predetermined range. In this manner, when the arm is within a predetermined range, it is made possible to replace a component therewith, and whether the component attachment is appropriate can be indicated by exposing the arm or the component to light.

(9) Further, it is a feature that the X-ray measurement apparatus according to the present invention is the apparatus, wherein the indicator indicates whether the attachment is appropriate by color of light, blinking, light-on or light-off. For example, the indicator indicates in green when the attachment is appropriate, and the indicator indicates in red when the attachment is inappropriate, and thus it is able to tell a current situation to an operator to understand easily.

(10) Further, it is a feature that the system according to the present invention is a system comprising the X-ray measurement apparatus according to any one of the above-described (1) to (9); and a control device provided with a storage section that stores a correspondence relation between the measurement category and each of the target components to be directly or indirectly attached to the apparatus body for the measurement category, an input section that receives input of the selected measurement category, a determination section that determines whether each of the attached target components is appropriate for the measurement category, by comparing the type of each of the target components determined from the selected measurement category, and the type of each of the target components detected by a sensor, and a control device provided with a transmission section that transmits an indicating instruction of appropriateness or inappropriateness obtained by the determination, to the X-ray measurement apparatus. In this manner, whether the component attachment is appropriate is determined by a processing device, and the X-ray measurement apparatus is able to indicate whether the attachment thereof is appropriate, based on the foregoing determination result.

According to the present invention, whether each of components to be replaced or each of replaced components is appropriate can be intuitively recognized only from visual information at a working site, without any confirmation by shifting eyes or moving a body.

### BRIEF DESCRIPTION OF THE DRAWINGS

FIG. 1 is a diagram showing an outline of a system according to the first embodiment.

FIG. 2 is a perspective view showing an X-ray measurement apparatus (X-ray diffractometer) according to the first embodiment.

FIG. 3 is a perspective view showing an example of not only a base component but also a functional component.

FIG. 4 is a block diagram showing a control configuration of sensing and indication of a system according to the first embodiment.

FIG. 5 is a flowchart showing an operation of a control device.

FIG. 6 is a flowchart showing an operation of an X-ray measurement apparatus (X-ray diffractometer) according to the first embodiment.

FIG. 7 is a table showing commands for instructing turning-on and turning-off of a lamp.

FIG. 8 is a perspective view showing a connector.

FIG. 9 is a diagram showing an indication example with lamps.

FIG. 10 is a diagram showing examples each of a display screen.

FIG. 11 is a sectional side view showing an X-ray measurement apparatus (X-ray diffractometer) according to the second embodiment.

FIG. 12 is a diagram showing an indication example from an upper light source.

FIG. 13 is a diagram showing an indication example from a front lower light source.

### DETAILED DESCRIPTION OF EMBODIMENTS

Next, embodiments of the present invention will be described referring to the drawings. In order to facilitate understanding of the description, one same reference number is used for one same constituent element, and overlapping descriptions will be omitted in each drawing.

### First Embodiment

### System

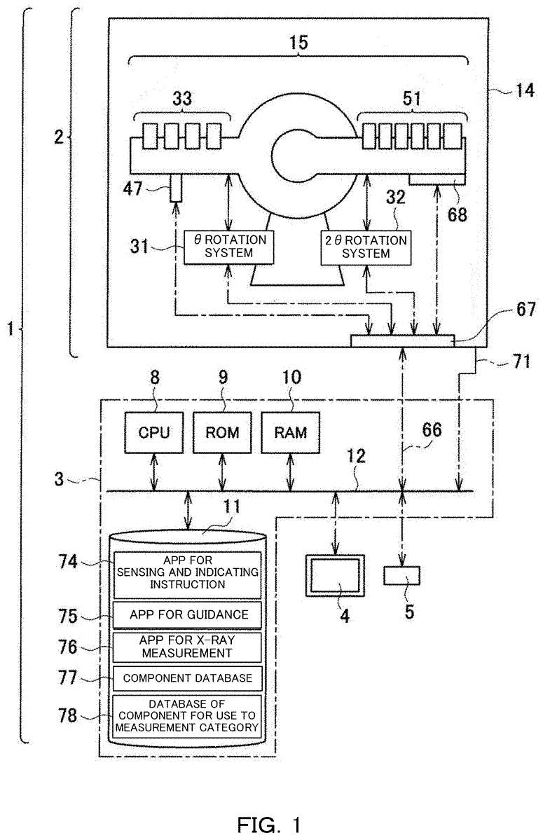

FIG. 1 is a diagram showing an outline of a system according to the present invention. As shown in FIG. 1, the system 1 according to the present embodiment comprises an X-ray diffractometer 2, a control device 3, a display device 4, and an input device 5. The X-ray diffractometer 2 is a measurement system in which X-rays coming out from a sample, for example, diffracted X-rays are detected by an X-ray detector, when X-rays being irradiated to the sample.

The control device 3 is a device for controlling the operation of the X-ray diffractometer 2, and processing the measurement data obtained by the X-ray diffractometer 2. The display device 4 is a device for displaying various data as images on a screen, for example, a flat display panel such as a liquid crystal display device or the like. The display device 4 may be inside or outside the X-ray diffractometer 2. The input device 5 is a device used when an operator inputs data to the control device 3, for example, a keyboard, a mouse, or the like.

According to the present embodiment, the control device 3 is constituted of a computer system formed by connecting CPU (Central Processing Unit) 8, ROM (Read Only Memory) 9, RAM (Random Access Memory) 10 and a memory 11 to a bus 12. The display device 4 and the input device 5 are connected to the CPU 8 via an appropriate interface.

### X-ray Diffractometer

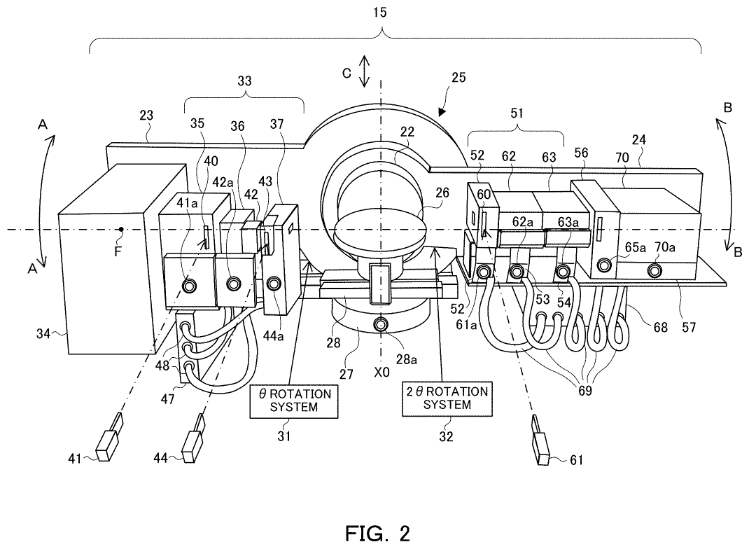

FIG. 2 is a perspective view showing an X-ray diffractometer 2. The X-ray diffractometer 2 comprises an X-ray shield case 14 capable of shielding X-rays, and a measurement operating system 15 arranged inside the X-ray shield case 14.

The measurement operating system 15 comprises a goniometer (angle measuring device) 25 provided with an incident side arm 23 and a receiving side arm 24, as shown in FIG. 2. Each of output lines of an interface substrate 47, a θ rotation system 31, a 2θ rotation system 32 and an interface substrate 68 is connected to a terminal on the measurement side of an internal controller 67. A terminal on the control side of the internal controller 67 is connected to the CPU 8 of the control device 3 by a LAN cable 66.

The θ rotation system 31 is connected to the incident side arm 23. The 28 rotation system 32 is connected to the receiving side arm 24. The incident side arm 23 is driven by the θ rotation system 31, to rotate centering a sample center line X0 that is a horizontal line passing through the surface of a sample, as shown by the arrow A-A. The receiving side arm 24 is driven by the 2θ rotation system 32, to be rotated with the sample center line X0 as a center, as shown by the arrow B-B.

The θ rotation system 31 and the 2θ rotation system 32 can be respectively constituted of a rotation drive structure that is an optional structure. According to the present embodiment, a motor capable of controlling a rotation angle, for example, a servo motor, a pulse motor or the like is used as a power source, and employed is a rotation system to transmit the power to each arm via a power transmission system constituted of a worm and a worm wheel.

The apparatus body of the measurement operating system 15 is constituted of an optical system in which X-rays are irradiated to a supported sample in order to scatter the X-rays at the sample, and it is possible to attach a component directly or indirectly thereto.

The X-ray diffractometer 2 is constituted of a measurement system of X-ray analysis on the measurement operating system 15. The measurement system is constituted of an incident optical system including an X-ray tube, a sample table, and a receiving optical system including an X-ray detector. As shown in FIG. 2, optical components on the incident side are arranged between the X-ray tube and the sample table. Optical components on the receiving side are arranged between the sample table and the X-ray detector. A plurality of installable components are provided for every part, and from among these, it is possible to combine components and attach thereto, depending on the desired measurement category.

### Each Target Component

Next, the target component to be attached thereto will be described referring to examples.

### Sample Table Part

The sample table part is constituted of an attachment base 27, an attachment head 28, and a sample plate 26. The attachment base 27 is provided with an upward/downward drive mechanism, a swing mechanism, a rotation mechanism and so forth. The attachment base 27 is attached to an attachment base attaching part 22 included in an apparatus body, and the attachment base attaching part 22 is provided at a central part of a goniometer 25. It is possible to attach the sample plate 26 in different shape (a glass sample plate, a wafer sample plate, or a capillary) to the attachment head 28, which is provided with a translation mechanism, a swing mechanism and so forth. When the attachment base 27 is driven in an upper/lower direction C, the attachment head 28 and the sample plate 26 move upward and downward by the driving.

The attachment base 27 is attached to the apparatus body. The apparatus body is provided with an LED lamp as an indicator 27a for the attachment base that indicates whether the attachment base 27 is appropriately attached thereto.

The attachment head 28 is attached onto the attachment base 27. An LED lamp as an indicator 28a for the attachment head that indicates whether the attachment head 28 is appropriately attached thereto is provided onto the attachment base 27. The sample plate 26 is attached onto the attachment head 28. Further, a sample is appropriately attached onto the sample plate 26.

As described above, the present embodiment exemplifies a standard attachment base 27, a standard attachment head 28 and a 4-inch wafer sample plate 26 that are provided with a Z-axis stage. Other than the foregoing, for example, the attachment base 27 and the attachment head 28 that are provided with a swing mechanism and a rotation mechanism for a sample, a translation mechanism and so forth are available, and are attachable and detachable. The configuration around a sample table largely differs therefrom according to the sample shape and purpose, and thus each indicator can be appropriately provided at the position corresponding to shapes of the apparatus body and the attachment base 27 (not shown in FIG. 2).

### Irradiating Optical System

The incident side arm 23 supports an X-ray tube 34 and an incident optical system component group 33. The incident optical system component group 33 comprises a CBO (Cross Beam Optics) unit 35, an incident side first optical device unit, and an incident slit box 37.

An X-ray source, as an X-ray focal point F, is present inside the X-ray tube 34. A type of tube bulb for the X-ray tube 34 may be any of a sealing type tube bulb and a rotary anticathode X-ray tube. In either case, the tube bulb is able to be removed therefrom. In addition, regarding a tube bulb in which a target is made of different metal, it can also be indicated whether its attachment is appropriate, though not being shown in FIG. 2.

### CBO Unit

The CBO unit 35 is a unit for forming X-rays of intensity and cross-sectional shape corresponding to each measurement category (for example, powder measurement, small-angle scattering measurement, fine area measurement, in-plane measurement, and so forth). A multilayer mirror is present inside the CBO unit 35.

A plurality of units as multilayer mirrors each of whose type is different therefrom are available, and are attachable and detachable. A motor for adjusting the position of the multilayer mirror is installed inside the CBO unit 35. A driver for controlling the rotation of an output shaft of the motor is installed in an interface substrate 47. The motor and the driver inside the interface substrate 47 are connected with each other by a communication cable 48 that is a communication line. A connector on the apparatus body side of the communication cable is provided with an LED lamp as a CBO unit indicator for indicating whether attachment of the CBO unit 35 is appropriate. A hollow block may be arranged at a place where the CBO unit 35 is attached, in place of the CBO unit 35. Such a hollow block is often referred to as an incident path.

The CBO unit 35 is also provided with a slit insertion hole 40. A selection slit 41 can be inserted into this slit insertion hole 40. The inserted selection slit 41 is to be located on the X-ray emitting side of the multilayer mirror.

A plurality of selection slits 41 each having different slit width or position thereof are available depending on the measurement category. For example, there are provided a selection slit BB as a slit for a convergence method, and a selection slit PB as a slit for a parallel beam method. Further, there is provided a pinhole (PB 0.1 mm) for which a slit width of the slit for the parallel beam method is set to 0.1 mm, for use in the small-angle scattering measurement.

An LED lamp as an indicator 41a for a selection slit that indicates whether the selection slit 41 is appropriately attached thereto is provided on the CBO unit 35. In addition, the communication cable 48 is also used in communication for sensing the attachment of the CBO unit 35 as well as the selection slit 41 to the CBO unit 35, or for indicating them with the indicator 41a for a selection slit.

### Incident Side First Optical Device Unit

The incident side first optical device unit comprises an incident element base 36 and an incident side first optical device 42. The incident element base 36 is attached to the apparatus body and the communication cable 48 is connected thereto. An LED lamp as an indicator for the incident element base that indicates whether attachment of the incident element base 36 is appropriate is provided to the connector on the apparatus body side of the communication cable 48.

Regarding the incident side first optical device, there are a separation type unit obtained by attaching the incident side first optical device 42 onto the incident element base 36 in an attachable and detachable manner, and an integrated type unit that the incident element base 36 and an optical device are integrated into. Further, there is also a coexisting type unit that is possible to be attached the incident side first optical device 42 that is able to be attached and detached thereto, while also being an integrated type unit.

Regarding the separation type unit and the coexisting type unit, on the incident element base 36, provided is an LED lamp as an indicator 42a for the incident side first optical device that indicates whether the incident side first optical device 42 is appropriately attached thereto.

As an incident element base 36, for example, any one of the following is attached to the apparatus body.

A IPS (Irradiating Parallel Slit) adapter (Irradiating parallel slit adapter)

B Four-crystal monochromator

C Two-crystal monochromator

A plurality of soller slits each for suppressing divergence of generated X-rays and in-plane PSCs (Parallel Slit Collimator) each for forming parallel beams for the in-plane measurement are available as incident side first optical devices 42. In addition, there are some cases where no incident side first optical device unit is provided.

### Incident Slit Box

The incident slit box 37 is attached to the apparatus body, and the communication cable 48 is connected thereto. An LED lamp as an indicator for incident slit box that indicates whether attachment of the incident slit box 37 is appropriate is provided to the connector on the apparatus body side of the communication cable 48.

The incident slit box 37 is provided with a slit insertion hole 43. A manual slit 44 can be inserted in this slit insertion hole 43. An LED lamp as an indicator 44a for the manual slit that indicates whether the manual slit 44 is appropriately attached thereto is provided on the incident slit box 37.

A plurality of Length-limiting slits each for restricting an irradiation width in a longitudinal direction of X-rays and collimators each that form X-rays to a fine point on a sample are available for the manual slit 44.

A slit for restricting the irradiation width in a travel direction of X-rays is also provided in the incident slit box 37, and a motor for opening/closing the slit that opens upward and downward is installed therein. A driver for controlling rotation of an output axis of the motor is installed in the interface substrate 47. The above-described motor and the driver inside the interface substrate 47 are connected with each other by the communication cable as a communication line. Further, the communication cable 48 is also used in communication for sensing attachment of the slit box 37 and the manual slit 44 to the incident slit box 37, or for performing indicating with the indicator 44a for a manual slit.

### Receiving Optical System

As shown in FIG. 2, the receiving side arm 24 supports the receiving optical system component group 51, an attenuator box 56, and an X-ray detector unit. The receiving optical system component group 51 comprises the first receiving slit box 52, a receiving side first optical device unit, and a receiving side second optical device unit.

### Receiving Slit Box

The receiving slit box 52 is attached to the apparatus body, and the communication cable 69 is connected thereto. An LED lamp as an indicator for the incident slit box that indicates whether attachment of the receiving slit box 52 is appropriate is provided to the connector on the apparatus body side of the communication cable 69.

A receiving slit and a motor for opening/closing the slit are installed in the receiving slit box 52. Further, the receiving slit box 52 is provided with a filter insertion hole 60. The filter 61 can be inserted into this filter insertion hole 60. An LED lamp as an indicator 61a for the filter that indicates whether the filter 61 is attached thereto is provided onto the receiving slit box 52.

### Receiving Side First Optical Device Unit

The receiving side first optical device unit comprises a first receiving element base 53 and a receiving side first optical device 62. The first receiving element base 53 is attached to the apparatus body, and the communication cable 69 is connected thereto. An LED lamp as an indicator for the first receiving element base that indicates whether attachment of the first receiving element base 53 is appropriate is provided to the connector on the apparatus body of the communication cable 69.

As the receiving side first optical device unit, there are a separation type unit obtained by attaching the receiving side first optical device 62 that is able to be attached and detached onto the first receiving element base 53, and an integrated type unit obtained by integrating the first receiving element base 53 and the receiving side first optical device 62 with each other.

As a first receiving element base 53, for example, either one of the following is attached to the apparatus body.

D an ROD adapter (receiving optical device adapter)

E 2-crystal analyzer, 4-crystal analyzer

An LED lamp as an indicator 62a for the receiving side first optical device that indicates whether the receiving side first optical device 62 is appropriately attached thereto is provided onto the first receiving element base 53. Every kind of PSA or a vacuum path each for restricting horizontal divergence of X-rays diffracted by a sample is available as receiving side first optical devices 62.

There are some cases where no receiving side first optical device unit is provided. In addition, a space often remains as it is without attaching the receiving side first optical device 62 onto the first receiving element base 53.

### Receiving Side Second Optical Device Unit

The receiving side second optical device unit comprises the second receiving element base 54 and the receiving side second optical device 63. The second receiving element base 54 is attached to the apparatus body, and a communication cable 69 is connected thereto. An LED lamp as an indicator for the second receiving element base that indicates whether attachment of the second receiving element base 54 is appropriate is provided to the connector on the apparatus body side of the communication cable 69.

According to the receiving side second optical device unit, the receiving side second optical device that is able to be attached and detached is attached onto the second receiving element base 54. The second receiving element base 54 is an RPS adapter (Receiving Parallel Slit Adapter). An LED lamp as an indicator 63a for the receiving side second optical device that indicates whether the receiving side second optical device 63 is appropriately attached thereto is provided onto the second receiving element base 54.

A plurality of soller slits each for restricting vertical divergence of X-rays diffracted by a sample, and in-plane PSA (Parallel Slit Analyzer) each for taking out diffraction beam with high parallelism for the in-plane measurement are available for the receiving side second optical devices 63. In addition, there are some cases where no receiving side second optical device unit is provided. A slit box is appropriately arranged when using a scintillation counter (zero-dimensional detector).

### Attenuator Box

An attenuator is provided inside the attenuator box 56. Further, provided is a motor for changing the type of attenuator inside the attenuator box 56. There are some cases where no attenuator itself is provided depending on the type of detector.

### X-ray Detector Unit

The X-ray detector unit comprises an X-ray detector base 57 and an X-ray detector 70. The X-ray detector base 57 is attached to the apparatus body, and the communication cable 69 is connected thereto. An LED lamp as an indicator for the X-ray detector base that indicates whether attachment of the X-ray detector base 57 is appropriate is provided to the connector on the apparatus body side of the communication cable 69.

Each of X-ray detectors, whose type is different therefrom, can be installed thereon as an X-ray detector 70. For example, exemplified are (1) one-dimensional semiconductor detector, and (2) a multi-dimensional semiconductor detector. The X-ray detector 70 is attached to the X-ray detector base 57. A plurality of holders each are available as an X-ray detector base 57 depending on the type as well as the style of placement (horizontal placement or vertical placement) of the X-ray detector. An LED as an indicator 70a for the X-ray detector, that indicates whether the detector is appropriately attached thereto is provided to the X-ray detector base 57.

A driver for controlling rotation of an output axis of a motor inside each box of a beam receiving slit box 52 and an attenuator box 56 is installed in an interface substrate 68. The motor inside each box and the driver inside the interface substrate 68 are connected with each other by a communication line as the communication cable 69. The communication cable 69 is also used in communication for sensing attachment of each box, and attachment of a slit or the like to each box, or for performing indicating on an indicator that indicates whether the attachment of the slit or the like attached to each box is appropriate.

### Base Component and Functional Component

According to components each attached to the X-ray diffractometer 2 as described above, there are provided target components each to be attached, whose type can be selected, and non-target components each whose type cannot be selected from among a plurality of types, depending on the desired measurement category. Then, the components (target components) each to be attached, whose type can be selected from among a plurality of types, depending on the measurement category, the components each attached thereto, are divided into base components and functional components. Each of the base components is a component attached to the apparatus body, and each of the functional components is a component attached to the base component.

There are provided a case where the attached target component is appropriate, and another case where the attached target component is not appropriate, according to the measurement category. It is simple and preferred that the measurement category is designed to be selected by an operator, but it may be designed to be automatically selected by AI or the like. It is possible to indicate whether attachment of any of a base component and a functional component is appropriate to an operator, but it is preferred that each indication method is different. The base component that is electrically connected by a connector enables information transmission to an internal controller 67.

The functional component is provided with a sensor on an interface with the base component or at an appropriate place, and the type of functional component attached to the base component is designed to be able to be detected. According to the present embodiment, an identification sticker is attached onto the interface for every functional component, and is designed to be able to be distinguished by a light sensor provided on the base component. Used may be a radio in communication for performing sensing, or for performing indicating on an indicator that indicates whether the attachment is appropriate.

As shown in FIG. 2, not only one as a base component single body but also one obtained by further attaching a functional component to the base component is exemplified as an target component to be attached thereto. Basically, an indicator for indicating whether the base component is appropriate is provided to the apparatus body, and an indicator for indicating whether the functional component is appropriate is provided to the base component. In this manner, a component position is able to be exactly indicated at the indicator even in a state where the base component and the functional component are not attached thereto.

The indicator with respect to the base component can indicate whether attachment of the base component is appropriate, on the apparatus body, for example, at a position of the connector of the communication cable 48. Further, the indicator with respect to the functional component indicates whether attachment of the functional component is appropriate, on an attachment object to which the functional component is attached, with an LED lamp, for example. In this manner, information is accessible even at the working site via indicating to a position where whether attachment of the base component as well as the functional component is appropriate is easy to be found. It is preferred to use a lamp as indication means, and specifically, an LED lamp is preferably used. When using an LED lamp, it is easy to arrange the lamp, and it exhibits high durability.

Whether attachment of the component is appropriate can be indicated by an indicator on the apparatus body or the base component. Regarding a component attached to the base component, it is possible to indicate whether the attachment thereof is appropriate, on the base component by an LED lamp or the like. For whether attachment of the component is appropriate, it is preferred from the viewpoint of intuitively easy recognition to be indicated, for example, by color of light, blinking light-on or light-off.

In this manner, when an operator needs to replace a component therewith for the replacement of a measurement category, whether a component to be replaced or a replaced component is appropriate is not necessary to be confirmed by shifting eyes or moving a body. That is, it enables the operator to recognize whether attachment of the component is appropriate, only from visual information at a working site. Further, information can be easily recognized even when it is not appropriate to be guided by sound or voice.

In addition, the indicator preferably indicates whether the attachment is appropriate, near the position of connecting an attachment object to the functional component and in front of a working position of the operator. In this manner, the operator can confirm whether a component to be replaced or a replaced component is appropriate at a position that is easy to be viewed during the operation, when replacing the component therewith. In addition, the indicator may be on an upper face or a lower face in a vertical direction of the working position, when being at a position that is easy to be viewed an operator.

Out of the above-described components, those corresponding to base components are an attachment base 27, a CBO unit 35, an incident element base 36, an incident slit box 37, a receiving slit box 52, a first receiving element base 53, a second receiving element base 54, an attenuator box 56, and an X-ray detector base 57.

Further, those corresponding to functional components are an attachment head 28, a selection slit 41, an incident side first optical device 42, a manual slit 44, a filter 61, a receiving side first optical device 62, a receiving side second optical device 63, and an X-ray detector 70.

Basically, regarding the base component, whether the attachment is appropriate can be notified by illuminating a connector on the apparatus body side of the communication cable with an LED or the like. Further, regarding the functional component, whether the attachment is appropriate can be notified by turning-on/off of an LED lamp. In addition, each of the components as exemplified above is part of the examples, and various other components can be practically utilized.

### One Example of Base Component as Well as Functional Component

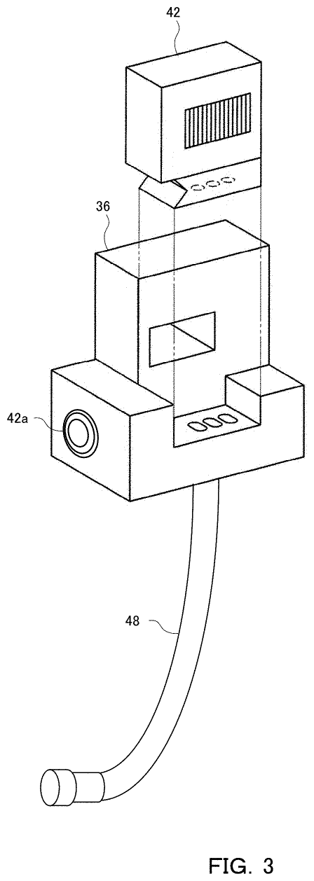

FIG. 3 is a perspective view showing an example of not only a base component but also a functional component. In FIG. 3, shown are an incident element base 36, an incident side first optical device 42, an indicator 42a for the incident side first optical device, and a communication cable 48. According to an example shown in FIG. 3, the incident element base 36 is a base component, and the incident side first optical device 42 is a functional component. Depending on the measurement category, the incident element base 36 is attached to the body of the X-ray diffractometer 2, and the incident side first optical device 42 is attached to the incident element base 36.

At this time, the attachment of each component, and whether it is appropriate are notified to the control device 3 by the communication cable 48. Then, when the incident element base 36 that is appropriate to the measurement category is not attached thereto, it is indicated that the attachment is not appropriate at a connector position of an X-ray diffractometer 2 body of the communication cable 48. For example, there is an indication method by which red and green LEDs are arranged to the connector to turn them on. Further, whether the incident side first optical device 42 is appropriate is indicated by lighting color of an LED lamp, light-on or light-off at an indicator 42a for the incident side first optical device. For example, green as being appropriate, and red as being inappropriate are possible to be indicated.

### Measurement Category

According to the present embodiment, every type of measurement can be carried out by appropriately replacing a component therewith in the measurement operating system 15 shown in FIG. 2. For example, a convergence method measurement, an in-plane measurement, a small-angle scattering measurement, a fine area measurement, and various other measurements can be carried out. In order to conduct these measurements, optical components each are appropriately replaced therewith to constitute an optimum optical system. For example, when conducting the small-angle scattering measurement using the convergence method measurement, the in-plane measurement and a two-dimensional detector, optical components shown in the following Table 1 are selectively used in the measurement operating system 15 shown in FIG. 2.

| | | | Small-angle |
|---|---|---|---|
| | Convergence | | scattering |
| | method | In-plane | measurement |
| | measurement | measurement | (2D) |
| CBO unit | CBO | CBO | CBO |
| CBO selection | BB | PB | Pinhole |
| slit | | | (PB 0.1 mm) |
| Irradiating | IPS adapter | IPS adapter | IPS adapter |
| element base | | | |
| Incident side | Soller slit | In-plane PSC | Soller slit |
| first optical | | 1.0° | OPEN |
| device | | | |
| Irradiating | Present | Present | Present |
| slit box | | | |
| Manual slit | Length | Length | Collimator |
| | limiting slit | limiting slit | 0.05 mm |
| | 10 mm | 10 mm | |
| Receiving | Present | Present | Absent |
| slit box | | | |
| Filter | Kβ filter | Absent | Absent |
| First | Adapter | Adapter | Absent |
| receiving | | | |
| element base | | | |
| Receiving | PSA OPEN | PSA OPEN | Absent |
| side first | | | |
| optical | | | |
| device | | | |
| Second | Adapter | Adapter | Absent |
| receiving | | | |
| element base | | | |
| Receiving | Soller slit | In-plane PSA | Absent |
| side second | 5.0° | 1.0° | |
| optical | | | |
| device | | | |
| Attenuator | Present | Present | Absent |
| box | | | |
| Detector base | Holder for | Holder for | Holder for |
| | semiconductor | semiconductor | semiconductor |
| | one- | one- | multi- |
| | dimensional | dimensional | dimensional |
| | detector | detector | detector |
| | | | horizontal |
| | | | placement |
| Detector | Semiconductor | Semiconductor | Semiconductor |
| | one- | one- | multi- |
| | dimensional | dimensional | dimensional |
| | detector | detector | detector |

For example, when changing a measurement method from the convergence method measurement to the in-plane measurement, components described inside the thick lines of Table 2 need to be replaced therewith.

Further, when changing a measurement method from the in-plane measurement to the small-angle scattering measurement (2D), components described inside the thick lines of Table 3 need to be replaced therewith.

Although only changing of the measurement category is explained in the above-described examples, an attachment component thereof may be updated due to the change of a measurement condition. Not only the measurement category in a narrow sense but also the measurement condition is included in the measurement category.

For example, according to the in-plane measurement, in the case of a sample having a different size, a type of Length-limiting slit is changed in order to change an area where X-rays are irradiated. In this case, no measurement category is changed, but whether attachment thereof is appropriate is determined before the measurement when setting of the measurement condition is changed on a software.

### Control Device

As shown in FIG. 1, a memory 11 as a constituent element of the control device 3 is formed by a storage medium having an appropriate structure, for example, a hard disk or a semiconductor memory. As to the storage medium itself, there may be one medium or a plurality of media. Installed, that is, stored are an application software 74 for sensing and indicating instruction, an application software 75 for guidance, and an application software 76 for X-ray measurement inside the memory 11. In addition, regarding the software, those in combination may be installed. Further, stored are a component database 77 and a database of component for use 78 for measurement category inside the memory 11. In this manner, the memory 11 functions as a storage section for specifying a correspondence relation between the measurement category and a component to be used.

The application software 74 for sensing and indicating instruction is an application software for sensing the situation of an attachment component and instructing to indicate appropriateness or inappropriateness of the component attachment. The application software 75 for guidance is a software for guiding how to advance every type of X-ray measurement to an operator. Specifically, it is a software for realizing instruction of which type of X-ray component and which type of attachment have to be used in order to conduct a certain type of X-ray measurement.

The application software 75 for guidance is a software for selecting the measurement category depending on the purpose of analysis by an operator. Basically, a target measurement category is selected by the operator. The application software 75 for guidance may possess a function of proposing an appropriate measurement category based on a sample and target data when the operator does not know which measurement category should be selected. Further, the application software 75 for guidance is able to realize instruction which type of X-ray component and which type of attachment should be used, as well as at which position they should be arranged, in order to conduct a certain type of X-ray measurement.

The application software 76 for X-ray measurement is a software for realizing every type of X-ray measurement, for example, a convergence method measurement, a reflectance measurement, an in-plane measurement, a small-angle scattering measurement, a fine area measurement, and various other measurements, using a measurement operating system 15.

The component database 77 is a database for specifying the relationship between information of a position where a component is to be attached, and a position where an X-ray optical component is to be attached; and the relationship between the symbol corresponding to the position where the component is to be attached, and a position where the attachment is to be attached.

Further, the component database 77 is a database for specifying the relationship between information corresponding to a component type according to identification information, and the name of the X-ray optical component; and the relationship between information corresponding to the component type, and the name of the attachment.

The database of component for use 78 for measurement category is a database for specifying which X-ray component as well as attachment has to be arranged at which position, in order to realize every type of X-ray measurement, for example, a convergence method measurement, a reflectance measurement, an in-plane measurement, a small-angle scattering measurement, a fine area measurement, and various other measurements.

The CPU 8 in the control device 3 serves as a determination section that determines whether a component to be attached thereto is appropriate by comparing the measurement category selected by an operator, with the component detected by a sensor, based on the correspondence relation. The CPU 8 also serves as a transmission section for transmitting an indicating instruction of appropriateness or inappropriateness obtained by the determination to the X-ray diffractometer 2. In this manner, whether attachment of the component is appropriate is determined by the control device 3, and the X-ray diffractometer can indicate whether the attachment is appropriate, based on the determination result.

### Control Configuration of Sensing and Indicating

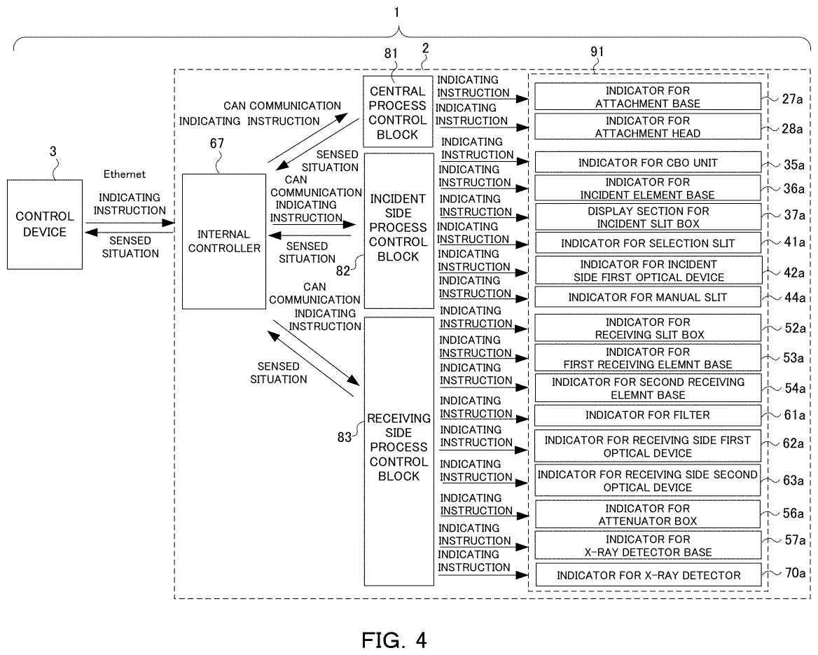

FIG. 4 is a block diagram showing a control configuration of sensing and indicating of the system 1. As shown in FIG. 4, the X-ray diffractometer 2 comprises a central process control block 81, an incident side process control block 82, a receiving side process control block 83, and an indicator 91.

The control device 3 that communicates with the X-ray diffractometer 2 receives whether each part from an internal controller 67 is attached thereto, and determines whether attachment of each part is appropriate depending on a sensed situation, with the attached component that receives the sensed situation of something if the foregoing part is attached thereto. Then, the control device 3 determines an indication content to an indicator for each part depending on the determination result to transmit the indicating instruction to each part.

The internal controller 67 provided inside the X-ray diffractometer 2 performs information collection and control inside a device. Specifically, information about the attachment situation at each part is collected to transmit the indicating instruction to each part as well as to each control block.

The central process control block 81 senses the attachment situation of an attachment base 27 and an attachment head 28 to transmit information to the internal controller 67. Further, the central process control block 81 instructs an indicator 27a for the attachment base, and an indicator 28a for the attachment head to indicate whether attachment of each part is appropriate.

The incident side process control block 82 senses the attachment situation of a CBO unit 35, an incident element base 36, an incident slit box 37, a selection slit 41, an incident side first optical device 42 and a manual slit 44 to transmit information to the internal controller 67. Further, the incident side process control block 82 instructs an indicator 35a for the CBO unit, an indicator 36a for the incident element base, an indicator 37a for the incident slit box, an indicator 41a for the selection slit, an indicator 42a for the incident side first optical device, and an indicator 44a for the manual slit to indicate whether attachment of each part is appropriate.

The receiving side process control block 83 senses the attachment situation of a receiving slit box 52, a first receiving element base 53, a second receiving element base 54, an attenuator box 56, a filter 61, a receiving side first optical device 62, a receiving side second optical device 63, and an X-ray detector 70 to transmit information to the internal controller 67. Further, the receiving side process control block 83 instructs an indicator 52a for the receiving slit box, an indicator 53a for the first receiving element base, an indicator 54a for the second receiving element base, an indicator 56a for the attenuator box, an indicator 61a for the filter, an indicator 62a for the receiving side first optical device, an indicator 63a for the receiving side second optical device, and an indicator 70a for the X-ray detector to indicate whether attachment of each part is appropriate.

### Operation of System

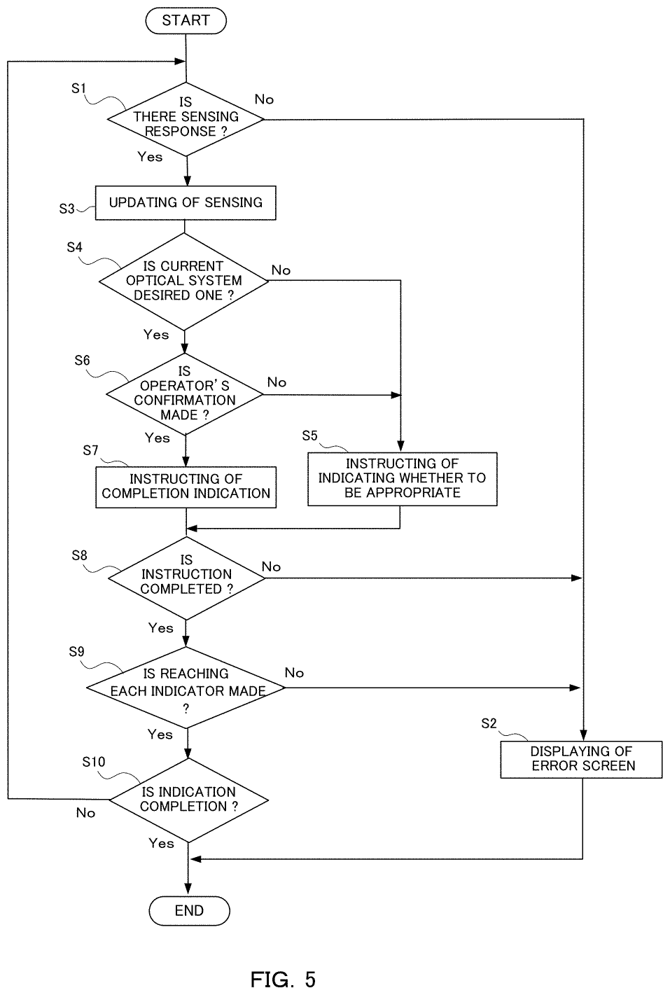

The operation of sensing and indicating with the system 1 constituted as described above will be explained. FIG. 5 is a flowchart showing an operation of the control device 3. As shown in FIG. 5, the control device 3 first confirms a sensed situation with respect to the internal controller 67 to determine whether there is a sensing response (step S1). When there is no sensing response, an error is indicated (step S2), and the operation ends. When there is a sensing response, the managed sensed situation is updated (step S3).

Then, whether an optical system realized by the component currently attached thereto is a desired one is determined (step S4). The desired optical system is specified when the measurement category to be executed is designated by an operator. When the current optical system is not a desired one, it is instructed to indicate whether the component attachment is appropriate (step S5), followed by advancing to step S8.

On the other hand, when the current optical system is the desired one in the step S4, whether to be confirmed is determined (step S6) by asking an operator for confirmation. When not being confirmed, it results in moving on to step S5. When being confirmed, an indication when the appropriate attachment is completed is instructed (step S7).

Next, whether instruction of either indication of whether to be appropriate or indication of completion has been completed is determined (step S8). When instruction is not completed, an error is indicated (step S2), and the operation ends. When the indicating instruction is completed, whether the indicating instruction reaches each indicator is determined (step S9), and when the indicating instruction is not reached, an error is indicated (step S2), and the operation ends.

When the indicating instruction reaches each indicator, whether to be appropriate or completion is indicated on the indicator by reaching of the instruction. Then, whether the indicating instruction indicates completion is determined (step S10), and when indicating the indication of completion, the control device 3 finishes the processing. When not indicating completion, it results in returning to step S1.

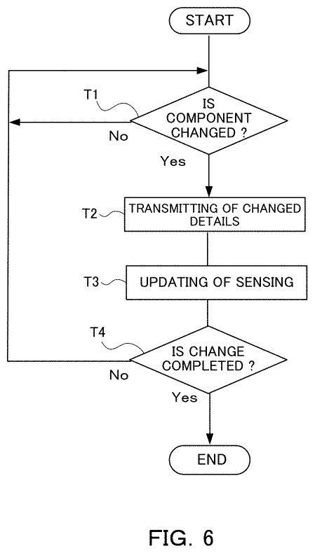

FIG. 6 is a flowchart showing an operation of the X-ray diffractometer 2. As shown in FIG. 6, regarding the X-ray diffractometer 2, each control block first determines whether a component has been changed (step T1). When the component not being changed, it results in returning to step T1. When the component being changed, each control block transmits changed details to an internal controller (step T2), and the internal controller updates a sensed situation managed by the content of the change (step T3). Then, whether updating has been completed is determined (step T4), and when the updating is completed, the processing is ended. When updating is not completed, it results in returning to step T1.

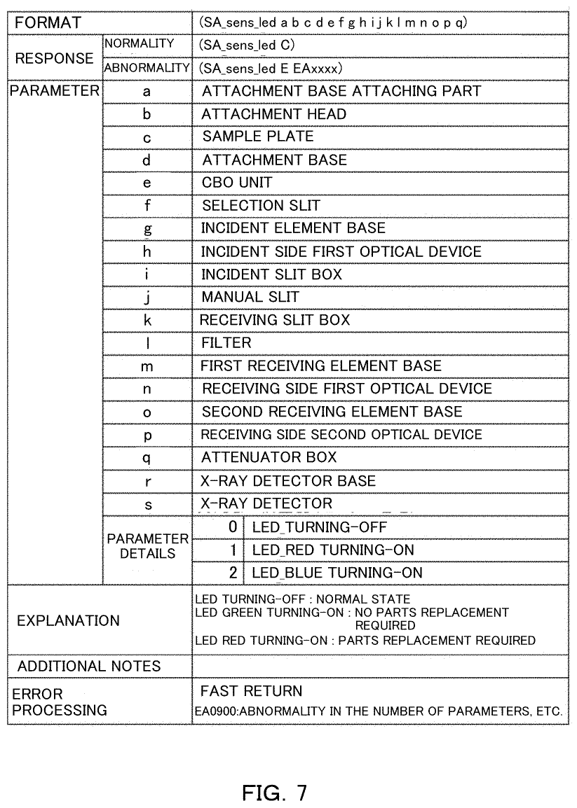

In addition, when it is instructed by the control device 3 to indicate whether the component attachment is appropriate, Commands for instructing turning-on/off of an indicator can be used. FIG. 7 is a table showing commands for instructing turning-on and turning-off of a lamp.

### Indication Example of Whether Attachment of Base Component is Appropriate

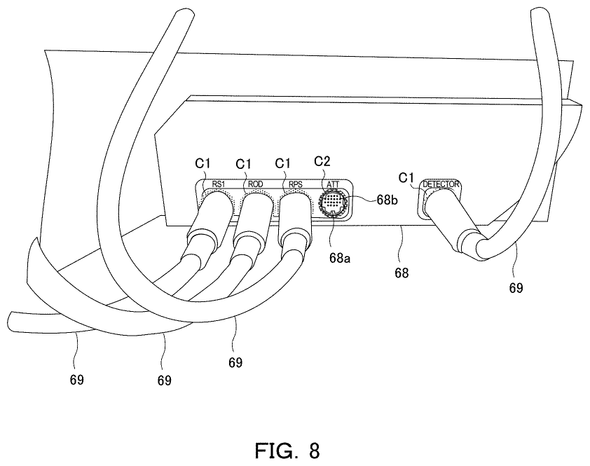

Regarding whether attachment of the base component is appropriate as described above, for example, it is preferred to indicate whether attachment thereof is appropriate at a position of a connector for being electrically connected to the base component in the X-ray diffractometer 2 body. FIG. 8 is a perspective view showing the connector. In an example shown in FIG. 8, each communication cable 69 is appropriately connected thereto, and a green LED arranged inside an interface substrate 68 at a connector position is turned on to perform green indication C1 of the connector, which indicates that RS1, ROD, RPS and DETECTOR are appropriately attached thereto. On the other hand, no communication cable is connected to ATT, and a red LED 68b arranged at the back of the connector 68a is turned on to perform red indication C2 of the connector, which indicates that the current state is inappropriate. In this manner, whether attachment of the base component is appropriate is enabled. An operator can confirm whether a component to be replaced or a replaced component is appropriate at a position that is easy to be viewed during an operation, when replacing a component therewith.

### Indication Example of Whether Attachment of Functional Component is Appropriate

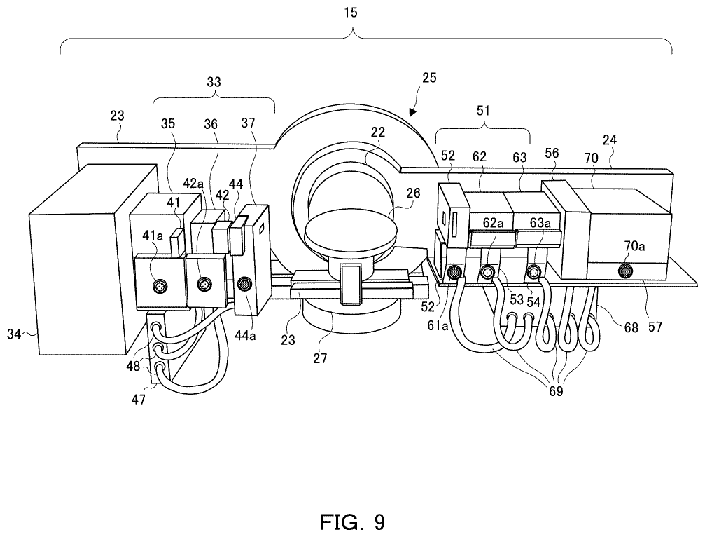

The case where an LED lamp is used as an indication example of whether attachment of the functional component is appropriate will be described. FIG. 9 is a diagram showing an example of turning on by lamps. In an example shown in FIG. 9, green turning-on indication C3 of an LED lamp as an indicator for each component is made when the attachment base 27, the selection slit 41, the incident side first optical device 42, the receiving side first optical device 62 and the receiving side second optical device 63 as components are appropriately attached thereto. On the other hand, regarding the manual slit 44 and the X-ray detector 70, red turning-on indication C4 of an LED lamp is made when a component does not match with the measurement category and is inappropriate even though being attached. Further, the filter 61 is not attached thereto, and thus it is indicated to be inappropriate by red lighting of an LED lamp. The indication examples of whether attachment of the base component as well as the functional component as described above is appropriate are preferable in terms of being comprehensible by an operator, but with no limitation thereto, each of various colors, blinking, light-on and light-off is possible to be selected for the indication.

Based on the above-described indications C1 to C4, explained is each of indication examples of whether attachment thereof is appropriate in the cases where the measurement categories are changed from a convergence method measurement to an in-plane measurement, and from the convergence method measurement to a two-dimensional small-angle scattering measurement, respectively.

First, the case where the measurement category is changed from the convergence method measurement to the in-plane measurement will be explained. Each of the selection slit 41, the incident side first optical device 42, the filter 61, and the receiving side second optical device 63 each uses a different component in respective optical systems. All of these are functional components, and no replacement of a base component is necessary. Accordingly, green indication C1 for the connector is made for all the connectors in the apparatus body, and it is to be understood by an operator that it is not necessary to change a base component, from the green indication C1 of the connector.

Next, it is assumed that the red lighting indication C4 of the LED lamp is made with respect to the CBO unit 35, the element base 36, the receiving slit box 52 and the second receiving element base, and the green lighting indication C3 of the LED lamp shall be made with respect to other base components. In this case, an operator is able to know without turning his/her eyes away from the apparatus that functional components for the selection slit 41, the incident side first optical device 42, the filter 61 and the receiving side second optical device 63 are inappropriate for conducting the in-plane measurement. Which component should be replaced from each of these inappropriate components can be known by looking at the display device 4. In addition, it will be mentioned later that the appropriate attachment of each component is guided onto the display device 4. When replacing the components therewith, the green lighting indication C3 of the LED lamp is conducted on all the LEDs, and the operator understands that the component replacement is correctly completed only by looking at the apparatus body.

Next, the case of changing from the convergence method measurement to the two-dimensional small-angle scattering measurement will be explained. According to respective incident optical systems, functional components of the selection slit 41 and the incident side first optical device 42 differ respectively. Accordingly, LED lamps of the incident element base 36 and the incident slit box 37 each conduct the red lighting indication C4 of the LED lamp. In this manner, an operator can understand that functional components of the incident side first optical device and the manual slit 44 are inappropriate for conducting the two-dimensional small-angle scattering measurement. When components therewith are replaced based on information of the display device 4, the green lighting indication C3 of the LED lamp is conducted for all of them.

Next, those other than the X-ray detector base 57 and the X-ray detector 70 are unnecessary in each of the receiving optical systems, and thus they all need to be removed therefrom. Further, types of the X-ray detector 70 differ therefrom in terms of the respective receiving optical systems. Accordingly, the state where the receiving slit box 52, the ROD adapter, the RPS adapter and the attenuator are connected with the apparatus body is inappropriate, and thus the red indication C2 of the connector is conducted for adaptors of these connection sections. When removing these communication cables 69 from the apparatus body, the green indication C1 of the connector is conducted other than DETECTOR, and an operator can understand that the state where these components are removed therefrom is appropriate. Further, when connecting a holder for semiconductor multi-dimensional detector horizontal placement to a terminal of DETECTOR, the green indication C1 of the connector is conducted also for DETECTOR. Further, when the X-ray detector 70 is installed on the X-ray detector base 57, the green lighting indication C3 of the LED lamp is conducted on X-ray detector base 57, and the operator understands that the component replacement is correctly completed only by looking at the apparatus.

### Example of Indication Screen

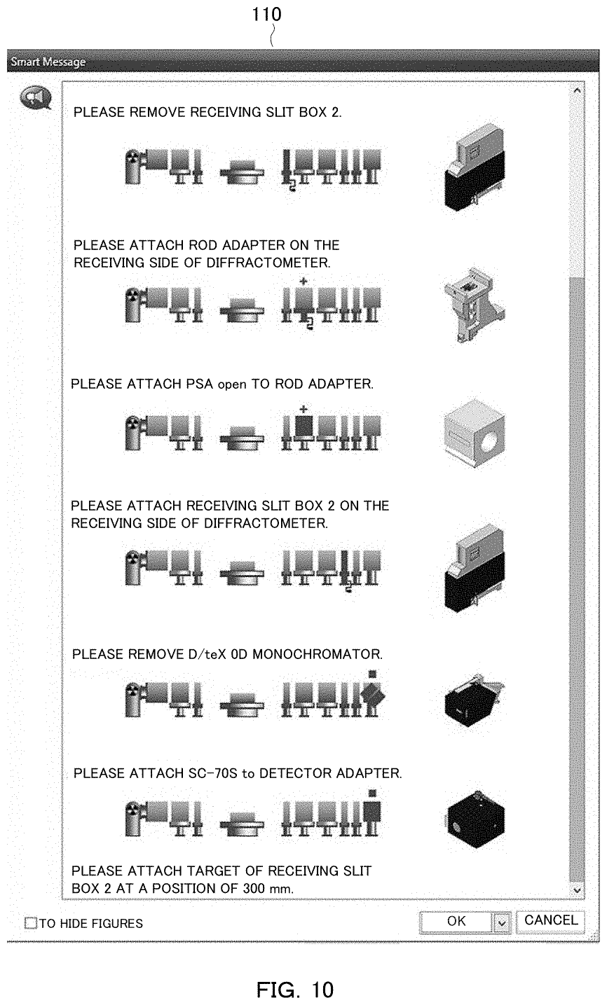

As described above, whether the component attachment is appropriate is indicated by each indicator of the X-ray diffractometer 2, and the appropriate attachment of each component is simultaneously guided for the display device 4. FIG. 10 is a diagram showing each of examples of the display screen 110. As shown in FIG. 10, it is able to specify the position and shape of components from a side view of the optical system, with a text of “PLEASE REMOVE BEAM-RECEIVING SLIT BOX”, for example. It may be possible to mirror these indications and display them by a display provided to the X-ray diffractometer 2.

### Second Embodiment

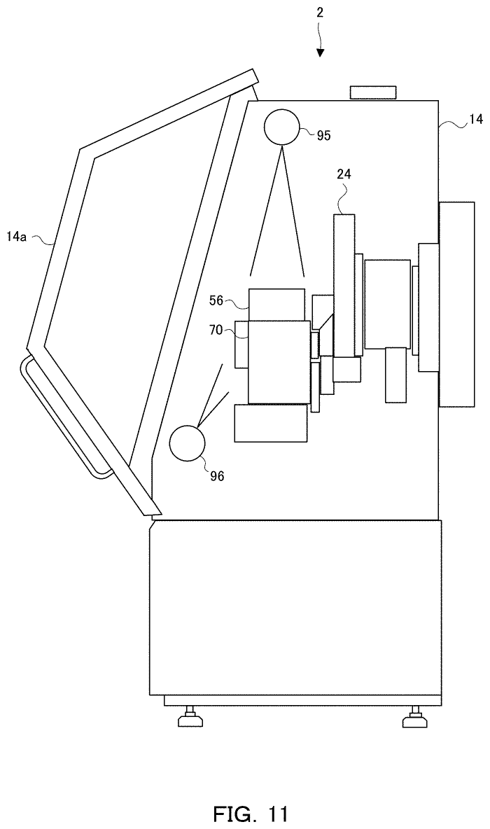

In the above-described example, the LED is used as an indicator, but a light irradiator such as a laser irradiator, projection mapping or the like can also be used. FIG. 11 is a sectional side view showing an X-ray measurement apparatus (X-ray diffractometer) 2. FIG. 11 shows a cross-section of the X-ray shield case 14 and a side face of its interior. As shown in FIG. 11, whether to be appropriate can be indicated on the apparatus body or on the component by arranging light sources 95 and 96 outside the measurement operating system 15 (for example, internal ceiling or inner wall of the X-ray shield case 14) in the X-ray diffractometer 2.

According to an example shown in FIG. 11, whether the attached component is appropriate can be indicated on the upper face or front face of each component in the measurement operating system 15 facing an operator who performs the component replacement by opening the front door 14a. In this case, for example, a light source 95 is arranged vertically above the measurement operating system 15, and whether the component is appropriate can be indicated on the vertically upper face of each component. Further, the light source 96 is arranged below the front of the measurement operating system 15, and whether the component is appropriate can be indicated in front of each component. Whether attachment of the functional component is appropriate can be indicated when light sources 95 and 96 as are arranged as described above, and thus whether the attachment is appropriate can be indicated without changing the configuration itself of the apparatus body or the components to be replaced in the X-ray diffractometer 2, as conventional.

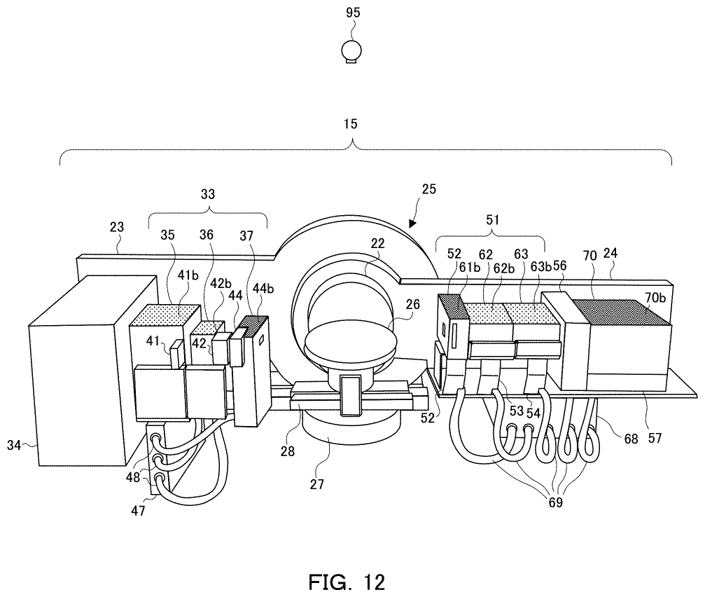

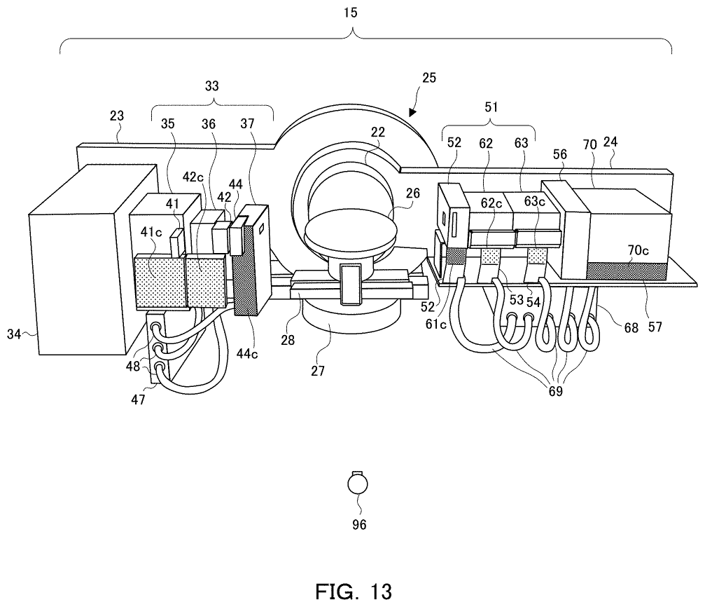

FIG. 12 is a diagram showing an indication example from the upper light source 95. FIG. 13 is a diagram showing an indication example from the front lower light source 96. According to FIG. 11 to FIG. 13, the light sources 95 and 96 are schematically drawn, but it is enabled to control color as well as shape depending on the irradiation direction of light. For example, as shown in FIG. 12, it can be indicated that the attachment of the selection slit 41 is appropriate by irradiating green light to the upper face of the housing of the CBO unit 35. Further, it can be indicated that the attachment of manual slit 44 is neither finished, nor appropriate by irradiating red light to the upper face of the incident slit box 37.

The techniques of laser pointer and projection mapping are applicable for controlling light irradiation. In this manner, whether attachment of the base component as well as the functional component is appropriate can be indicated by color and shape of light irradiated to the front exterior wall or upper face exterior wall in a housing of components.

In addition, in the example shown in FIG. 12 or 13, only whether the attachment of the functional component is appropriate is explained, but whether the attachment of the base component is appropriate may be indicated by irradiating light at the upper portion of the apparatus body. Further, whether the attachment is appropriate for only one of base components and functional components may be indicated by light irradiation. For example, whether the attachment is appropriate for functional components may be indicated by light irradiation, and whether the attachment is appropriate for base components may be indicated on the connector by an LED lamp.

According to laser irradiation, whether to be appropriate can be indicated at a position near the attachment component by color of a laser pointer having the same diameter as or larger diameter than a predetermined diameter. A light source of the laser irradiation is constituted of a light-emitting section and a communication cable, and the instruction of light emission/extinction is transmitted to the light source through the communication cable depending on whether the component attachment is appropriate.

The apparatus body is preferred to be able to indicate whether attachment of the base component or the functional component is appropriate when an arm constituting a basic optical system is within a predetermined range. For example, when the arm is within the predetermined range, setting of being switched to a replacement mode is designed to be made, and the component replacement is enabled only in this case. In that case, the component replacement is facilitated, which prevents accidents such as dropping a precise component on the floor, and so forth. Further, whether the component attachment is appropriate can be surely indicated by irradiating light to the arm or the component.

In addition, according to the above-described example, the type of component to be connected, the attachment situation and so forth are specified by a communication cable of a base component or a connector of the component connected to the base component, but the situation of attachment component may be specified by transmitting and receiving information via a radio communication by arranging a transceiver.

Further, there are various apparatuses capable of customizing components depending on the desired measurement as the X-ray diffractometer 2 explained as an example of the X-ray measurement apparatus used for a variety of analyses in the above-described example. For example, according to a fluorescence X-ray apparatus, a slit and a spectroscope correspond replacement objects, and in the case of an X-ray microscope, an X-ray lens corresponds a replacement object.

Accordingly, an analyzer capable of constituting a measurement system of X-ray analysis by arranging a plurality of components is able to be applied thereto. Specifically, the measurement category in which replacement of an attachment component becomes important is diffraction. Thus, it is preferable that the X-ray measurement apparatus is specifically an X-ray diffractometer.

### EXPLANATION OF THE SYMBOLS

1 System
2 X-ray diffractometer (X-ray measurement apparatus)
3 Control device
4 Display device
5 Input device
8 CPU
11 Memory
12 Bus
14 X-ray shield case
14a Front door
15 Measurement operating system
22 Attachment base attaching part
23 Incident side arm
24 receiving side arm
25 Goniometer
26 Sample plate
27 Attachment base
27a Indicator for attachment base
28 Attachment head
28a Indicator for attachment head
29 Upward/downward drive device
31 θ rotation system
32 2θ rotation system
33 Incident optical system component group
34 X-ray tube
35 CBO unit
35a Indicator for CBO unit
36 Incident element base
36a Indicator for incident element base
37 Incident slit box
37a Indicator for incident slit box
40 Slit insertion hole
41 Selection slit
41a Indicator for selection slit
42 Incident side first optical device
42a Indicator for incident side first optical device
43 Slit insertion hole
44 Manual slit
44a Indicator for manual slit
47 Interface substrate
48 Communication cable
51 receiving optical system component group
52 receiving slit box
53 First receiving element base
54 Second receiving element base
56 Attenuator box
57 X-ray detector base
60 Filter insertion hole
61 Filter
61a Indicator for filter
62 receiving side first optical device
62a Indicator for receiving side first optical device
63 Receiving side second optical device
63a Indicator for receiving side second optical device
66 LAN cable
67 Internal controller
68 Interface substrate
68a Connector
69 Communication cable
70 X-ray detector
70a Indicator for X-ray detector
74 Application software for sensing and indicating instruction
75 Application software for guidance
76 Application software for X-ray measurement
77 Component database
78 Database of component for use
81 Central process control block
82 Incident side process control block
83 receiving side process control block
91 Indicator
95, 96 Light source
A-A θ rotation
B-B 2θ rotation
C Upper/lower direction
C1 to C4 Indication
F X-ray focal point
X0 Sample center line

1. An X-ray measurement apparatus constituting a measurement system of X-ray analysis from a plurality of components, the X-ray measurement apparatus comprising:
an apparatus body directly or indirectly attaching each of target components and each of non-target components;
each of the target components to be attached, the type of the attached target component being recognized by the apparatus body;
each of the non-target components to be attached, the type of the attached non-target component not being recognized by the apparatus body; and
an indicator that indicates whether attachment of each of the target components is appropriate for a measurement category.

2. The X-ray measurement apparatus according to claim 1,
wherein the indicator indicates whether attachment of a base component is appropriate on the apparatus body, the base component being one of the target components directly attached to the apparatus body.

3. The X-ray measurement apparatus according to claim 2,
wherein the indicator indicates whether the attachment of the base component is appropriate on a connector for electrical connection.

4. The X-ray measurement apparatus according to claim 1,
wherein the indicator indicates whether attachment of a functional component is appropriate on the functional component or an attachment object to which the functional component is attached, the functional component being one of the target components attached to a base component, the base component being directly attached to the apparatus body.

5. The X-ray measurement apparatus according to claim 4,
wherein the indicator indicates whether the attachment is appropriate near a position of connecting the attachment object to the functional component and in front of a working position of an operator.

6. The X-ray measurement apparatus according to claim 1,
wherein the indicator is a lamp.

7. The X-ray measurement apparatus according to claim 1,
wherein the indicator is a light irradiator.

8. The X-ray measurement apparatus according to claim 7,
wherein the apparatus body allows to indicate whether the attachment of each of the target components is appropriate, after an arm constituting the apparatus body moves into a predetermined range.

9. The X-ray measurement apparatus according to claim 1,
wherein the indicator indicates whether the attachment is appropriate by color of light, blinking, light-on or light-off.

10. A system comprising:
the X-ray measurement apparatus according to claim 1; and
a control device provided with;
a storage section that stores a correspondence relation between the measurement category and each of the target components to be directly or indirectly attached to the apparatus body for the measurement category;
an input section that receives input of the selected measurement category;
a determination section that determines whether attachment of each of the attached target components is appropriate for the measurement category by comparing the type of each of the target components determined from the selected measurement category, and the type of each of the target components detected by a sensor; and
a transmission section that transmits an indicating instruction of appropriateness or inappropriateness obtained by the determination to the X-ray measurement apparatus.
